(19) United States
(12) Patent Application Publication
(10) Pub. No.: US 2003/0004280 A1
(43) Pub. Date: Jan. 2, 2003

(54) Composition and method of low warp fiber-reinforced thermoplastic polyamides

(76) Inventor: Robert R. Gallucci, Mt. Vernon, IN (US)

Correspondence Address: John B. Yates, GE Plastics, One Plastics Avenue, Pittsfield, MA, 01201, US

(21) Appl. No.: 09/883,553

(22) Filed: Jun. 18, 2001

(51) Int. Cl. C08F 8/30

(52) U.S. Cl. 525/432; 525/419

(57) ABSTRACT

Fiber reinforced thermoplastic blends of a at least one high melting crystalline polyamide containing at least one of polyetherimide or polysulfone resin having a high glass transition temperature provide molded parts with a high degree of flatness and dimensional stability. The fiber-reinforced resin composition has good load bearing capability at high heat and high mechanical strength compared to related fiber-reinforced polyamide compositions not containing the polyetherimide and polysulfone resin.

### CROSS-REFERENCE TO RELATED APPLICATIONS

Not applicable.

### FEDERALLY SPONSORED RESEARCH

Not applicable.

### FIELD OF THE INVENTION

The present invention is related to compositions of fiber-reinforced crystalline polyamides comprising at least one polyetherimide or polysulfone resin having a high glass transition temperature. The compositions provide articles having a high degree of flatness and dimensional stability. The invention also relates to methods of reducing the anisotropic behavior of fiber-reinforced crystalline polyamides. In a preferred embodiment, the fiber reinforcement is at least one of glass fiber and carbon fiber.

### DESCRIPTION OF THE RELATED ART

Fibers have long been used to improve the strength of thermoplastic resins and are particularly effective in crystalline resins. However, one drawback to fiber reinforcement is the loss of dimensional stability in articles made from such reinforced compositions, particularly a deviation from flatness often referred to as “warp.” Warped parts are especially problematic when the molded article is part of a device that needs to fit closely together with a second article, such as a connector or cover to an enclosure. Furthermore, for articles molded from relatively short fiber-reinforced crystalline resins that are exposed to an elevated temperature during fabrication or in actual end use, post fabrication crystallization may occur resulting in additional warpage.

It is believed that one cause of this problem is the orientation of the fiber in the article and the relatively large difference in shrinkage between the plastic resin and the fiber. Typical fibers do not melt at normal plastic resin processing temperatures and crystalline resins often exhibit relatively large changes in shrinkage upon crystallization. This combination of features is believed to result in anisotropic behavior with respect to shrinkage of the fiber-reinforced composition in molded articles and the resultant warpage may be hard to predict and control. Often parts and molds need to be redesigned several times to obtain an acceptable balance between physical properties and a part shape that has acceptable dimensional stability. This is a time consuming, costly and inefficient process.

It should be apparent that there is continuing need for fiber-reinforced materials with a good overall balance of properties including high heat capability, high strength, good solvent resistance, low flammability, good dimensional stability and low warp.

### DESCRIPTION OF THE INVENTION

The needs discussed above have been generally satisfied by the discovery of compositions of fiber-reinforced crystalline polyamides containing at least one high heat polyimide or polysulfone resin. The compositions possess an unexpected good overall balance of properties with low warp and high mechanical strength.

In preferred embodiments, the compositions comprise (based on the weight of the entire composition):

(a) 80-10 wt. % of a crystalline polyamide with a melting point greater than or equal to 270° C.,

(b) 10-50 wt. % of at least one fiber selected from the group consisting of glass fiber and carbon fiber and having a diameter between about 6 and about 20 microns, and

(c) 10-50-wt. % of an amorphous thermoplastic having a glass transition temperature above 170° C. selected from the group consisting of polyetherimides, polyimides, polyethersulfones and polysulfones.

Useful polyamides have a high crystalline melting point greater than or equal to 270° C., as measured by differential scanning calorimetry (DSC). Useful polyamides are generally known in the art, as are methods for their manufacture. Such polyamides may be made from mixtures of aromatic or aliphatic carboxylic acids combined with more or less equimolar amounts of aliphatic or aromatic diamines by methods known in the art. Preferred polyamides include poly(butylene adipamide), also known as nylon 4,6 and co-polyamides prepared by reaction of mixtures of carboxylic acids primarily composed of isophthalic and terephthalic acid with hexamethylene diamine. Polyamides made from mixtures of aromatic carboxylic acids and hexamethylene diamine are often known as polyphthalamide (PPA) polymers and are commercially available from numerous sources.

The crystalline polyamide resin will be present in an amount sufficient to be the continuous phase of the composition, generally from about 80-10 weight % of the total composition, with compositions having 65-30 weight % polyamide being preferred.

The fiber comprises from about 10 to about 50 weight percent of the composition, preferably from about 10 to about 35 weight percent based on the total weight of the composition. The preferred fibers are glass and carbon and are generally well known in the art as are their methods of manufacture. In one embodiment, glass is preferred, especially glass that is relatively soda free. Fibrous glass filaments comprised of lime-alumino-borosilicate glass, which is also known as “E” glass are often especially preferred. The filaments can be made by standard processes, e.g., by steam or air blowing, flame blowing and mechanical pulling. The preferred filaments for plastic reinforcement are made by mechanical pulling. For achieving optimal mechanical properties fiber diameter between 6-20 microns are required with a diameter of from 10-15 microns being preferred. In preparing the molding compositions it is convenient to use the fiber in the form of chopped strands of from about ⅛″ to about ½″ long although roving may also be used. In articles molded from the compositions, the fiber length is typically shorter presumably due to fiber fragmentation during compounding of the composition.

The fibers may be treated with a variety of coupling agents to improve adhesion to the resin matrix. Preferred coupling agents include; amino, epoxy, amide or mercapto functionalized silanes. Organo metallic coupling agents, for example, titanium or zirconium based organo metallic compounds, may also be used.

Fiber coatings having a high thermal stability are preferred to prevent decomposition of the coating, which could result in foaming or gas generation of the compositions during processing at the high melt temperatures required to form the resins of this invention into molded parts.

Other fillers and reinforcing agents may be used in combination with fibers. These include: carbon fibrils, mica, talc, barite, calcium carbonate, wollastonite, milled glass, flaked glass, ground quartz, precipitated silica, and solid or hollow glass beads or spheres.

Useful thermoplastic amorphous resins in the compositions of the present invention include polyimides, polysulfones and polyethersulfones. The amorphous resin should have a glass transition temperature (Tg), as measured by DSC, of greater than about 170° C., preferably greater than about 200° C. The Tg of the amorphous resin in important in order to produce high strength compositions having high load bearing capability at elevated temperatures while maintaining the desired low warp and good dimensional stability.

The amorphous resin portion of the compositions should be present in an amount such that it is present as a dispersed phase within the polyamide phase, usually from about 10-50 weight % of the entire composition. Higher levels of the high Tg amorphous resin are preferred for minimizing warp with concentrations of about 20-40 weight % of the entire composition most being preferred. The amorphous phase may be present as discrete spherical particles or may be present as striations or threads.

In some instances, especially with higher glass levels (≧30%) and higher amorphous resin content (≧35%), the flammability of the composition will be reduced as compared to the high warp polyamide glass compositions not containing the amorphous resin.

Polyaryl ether sulfones, also referred to as polysulfones, polyether sulfones and polyphenylene ether sulfones are thermoplastic polymers that possess a number of attractive features such as high temperature resistance, good electrical properties, and good hydrolytic stability. A variety of polyaryl ether sulfones are commercially available, including the polycondensation product of dihydroxydiphenyl sulfone with dichlorodiphenyl sulfone and known in the art as polyether sulfone (PES) resin, and the polymer of bisphenol-A and dichlorodiphenyl sulfone known in the art as polysulfone (PSF) resin. A variety of PES copolymers, for example, derived from Bisphenol A moieties and diphenyl sulfone moieties in molar ratios other than 1:1, are also known polymers useful in the present compositions.

Other useful polyaryl ether sulfones are the polybiphenyl ether sulfone resins, available from BP Amoco Polymers, Inc. under the trademark of RADEL R resin. These resins may be described as the product of the polycondensation of biphenol with 4,4′-dichlorodiphenyl sulfone and also are known and described in the art, for example, in Canadian Patent No. 847,963.

Methods for the preparation of polyaryl ether sulfones are widely known and several suitable processes have been well described in the art. There are two general methods used to prepare such materials: the carbonate method and the alkali metal hydroxide method. In the alkali metal hydroxide method, a double alkali metal salt of a dihydric phenol is contacted with a dihalobenzenoid compound in the presence of a dipolar, aprotic solvent under substantially anhydrous conditions. The carbonate method, in which at least one dihydric phenol and at least one dihalobenzenoid compound are heated, for example, with sodium carbonate or bicarbonate and a second alkali metal carbonate or bicarbonate has been disclosed in the art, for example in U.S. Pat. No. 4,176,222. Alternatively, the polybiphenyl ether sulfone, PSF and PES resin components may be prepared by any of the variety of methods known in the art for the preparation of polyaryl ether resins.

The molecular weight of the polysulfone, as indicated by reduced viscosity data in an appropriate solvent such as methylene chloride, chloroform, N-methylpyrrolidone, or the like, is preferably at least 0.3 dl/g, preferably at least 0.4 dl/g and, typically, will not exceed about 1.5 dl/g.

Thermoplastic polyethersulfones and their preparation are described in U.S. Pat. Nos 3,634,355; 4,008,203; 4,108,837 and 4,175,175.

Thermoplastic polyimides useful in the invention can be derived from the reaction of aromatic dianhydrides, aromatic tetracarboxylic acids, or their derivatives capable of forming cyclic anhydrides with aromatic diamines, or chemically equivalent derivatives, to form cyclic imide linkages.

Illustrative examples of aromatic bis anhydrides include: 2,2-bis(4-(3,4-dicarboxyphenoxy)phenyl)propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis([4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; -4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, as well as various mixtures thereof.

Most preferred dianhydrides are bisphenol-A dianhydride, benzophenone dianhydride, pyromellitic dianhydride, biphenylene dianhydride and oxy dianhydride.

Suitable aromatic organic diamines include, for example, m-phenylenediamine; p-phenylenediamine; 4,4′-diaminodiphenylpropane, 4,4′-diaminodiphenylmethane (commonly named 4,4′-methylenedianiline); 4,4′-diaminodiphenyl sulfide; 4,4′-diaminodiphenyl sulfone; 4,4′-diaminodiphenyl ether (commonly named 4,4′-oxydianiline); 1,5-diaminonaphthalene; 3,3-dimethylbenzidine; 3,3-dimethoxybenzidine; 2,4-bis(beta-amino-t-butyl)toluene; bis(p-beta-amino-t-butylphenyl)ether; bis(p-beta-methyl-o-aminophenyl)benzene; 1,3-diamino-4-isopropylbenzene; 1,2-bis(3-aminopropoxy)ethane; benzidine; m-xylylenediamine; and mixtures of such diamines.

The most preferred diamines are meta and para phenylene diamines and oxydianiline. The most preferred polyimide resins are polyetherimides.

Generally, useful polyimide resins have an intrinsic viscosity greater than about 0.2 dl/g, preferably of from about 0.35 to about 1.0 dl/g measured in chloroform or m-cresol at 25° C.

In a preferred embodiment, the high Tg amorphous resins of the present invention resin will have a weight average molecular weight of from about 10,000 to about 75,000 grams per mole (“g/mol”), more preferably from about 10,000 to about 65,000 g/mol, even more preferably from about 10,000 to about 55,000 g/mol, as measured by gel permeation chromatography, using a polystyrene standard.

The load bearing capability of a resin composition may be measured by its heat distortion temperature (HDT). HDT can be measured by numerous methods including ASTM D648. HDT is normally measured on a molded part 6×½×¼ inch thick specimen under a 264 psi load. HDT is recognized in the art as a indication of a material's ability to withstand a load at elevated temperatures for relatively short periods of time. The compositions of this invention preferably have a HDT measured at 264 psi of at least about 250° C.

A useful measure of a material's mechanical strength is its tensile strength, which can be measured as described in ASTM D638. High strength materials are useful in a variety if application particularly enclosures or connectors with snap fit fastenings. The compositions of this invention are preferred to have a tensile strength, as measured by ASTM D638 on ⅛ in thick molded parts, of at least about 20,000 psi.

The composition of the invention can also be combined with various additives including colorants such as titanium dioxide, zinc sulfide and carbon black; stabilizers such as hindered phenols, aryl phosphites, inorganic halides and thioesters, as well as mold release agents, lubricants, flame retardants, smoke suppressors, anti-drip agents, for example, those based on fluoro polymers. Ultra violet light stabilizers can also be added to the composition in effective amounts.

The compositions of the present invention can be prepared by a variety of methods involving intimate admixing of the materials with any additional additives desired in the formulation. A preferred procedure includes melt blending, although solution blending is also possible. Because of the availability of melt blending equipment in commercial polymer processing facilities, melt processing procedures are generally preferred. Examples of equipment used in such melt compounding methods include: co-rotating and counter-rotating extruders, single screw extruders, disc-pack processors and various other types of extrusion equipment. The temperature of the melt in the present process is preferably minimized in order to avoid excessive degradation of the resins. It is desirable to maintain the melt temperature between about 285° C. and about 370° C., although higher temperatures can be used provided that the residence time of the resin in the processing equipment is kept short. In some instances, the compounded material exits the extruder through small exit holes in a die and the resulting strands of molten resin are cooled by passing the strands through a water bath. The cooled strands can be chopped into small pellets for packaging and further handling.

The composition of the invention may be formed into shaped articles by a variety of common processes for shaping molten polymers such as injection molding, compression molding, extrusion and gas assist injection molding. Examples of such articles include electrical connectors, enclosures for electrical equipment, automotive engine parts, lighting sockets and reflectors, electric motor parts, power distribution equipment, communication equipment and the like including devices that have molded in snap fit connectors.

In many instances it is desirable to coat the article, or a portion of the article, of the invention with a metal surface. Such a coating may provide radio and electromagnetic wave shielding or reflectance. It may also provide the article with an electrically conductive pathway or surface. The coating may be of any metal; however, silver, copper, gold, nickel, aluminum, and chrome as well as alloys containing any of the foregoing are often preferred. The articles may have one or several metal coatings combining different metals or mixtures of metals.

The metal surface may be applied by many techniques known in the art, for example, sputtering or electroless metallization.

It should be clear that thermoplastic compositions made by the process described herein are another embodiment of the present invention. It should also be clear that articles formed out of the thermoplastic compositions described herein are another embodiment of the present invention.

All patents cited are incorporated herein by reference.

The invention will be further illustrated by the following examples.

### EXAMPLES

Control A in Table 1 provides a composition containing nylon 4,6 with 30 weight % of a 11 micron diameter borosilicate E-glass fiber and illustrates the high warp obtained when the composition is molded into an edge gated 4×1/16-in. disc. Example 1 illustrates the unexpected huge reduction in warp with the replacement of 28 weight % of a high Tg amorphous resin (polyetherimide) for nylon 4,6 in the composition. Note that flexural modulus, flexural and tensile strength, as well as HDT at 264 psi, are also unexpectedly improved.

The nylon 4,6 was a commercially available material. The polyetherimide used in the example is a polymer derived from BPA-dianhydride and meta phenylene diamine and is commercially available as ULTEM 1000 from the General Electric Company. The E-glass fiber was OC165A commercially available from the Owens Corning Company. It is an “E” glass treated with an amino silane coupling agent and having a diameter of 11 microns.

Exemplary conditions and procedures used in the manufacture of compositions of the present invention are as follows. The ingredients are compounded in a 2.5 inch vacuum vented single screw extruder with temperature settings over the length of the extruder between about 310 and about 330° C. at about 80 rpm screw speed. All ingredients are generally fed at the throat of the extruder. The strands coming from the extruder are pelletized and dried for about 3 hours at about 150° C. The dried pellets are injection molded into standard ASTM test specimens for measurement of physical properties. Physical properties were measured according to ASTM methods D638 for tensile properties, D790 for flexural properties and D648 for HDT. Warp was measured as the maximum deflection of a 4×1/16-inch disc from a flat surface on a part as molded or annealed for 0.5 h at 125° C. The warp disc was edge gated. The warp test is described in Plastics Engineering, May 1993, pp. 23-25.

TABLE 1

| Example | Control A | 1 |
|---|---|---|
| Polyamide 4, 6 | 60 | 42 |
| Fiber Glass OC165A | 30 | 30 |
| Polyetherimide | 0 | 28 |
| Warp as molded mm | 25 | 8 |
| Warp annealed | | |
| Tensile Str., Psi | 17,600 | 22,500 |
| % Elongation | 2.4 | 3.6 |
| Flex Str., Psi | 27,900 | 36,400 |
| Flex. Mod., Psi | 1,010,000 | 1,410,000 |
| HDT @ 264 psi ° C. | 260 | >280 |

The preceding examples illustrate specific embodiments of the invention and are not intended to limit its scope. It should be clear that the present invention includes articles from the compositions as described herein. Additional embodiments and advantages within the scope of the claimed invention will be apparent to one or ordinary skill in the art.

What is claimed is:

1. A thermoplastic resin composition comprising:
(a) about 80-10 wt. % of at least one crystalline polyamide resin having a melting point of greater than about 270° C.,
(b) about 10-50 wt. % fiber having a diameter between about 6-20 microns, and
(c) about 10-50-wt. % of at least one amorphous thermoplastic resin having a glass transition temperature above about 170° C. and selected from the group consisting of polyetherimides, polyimides, polyethersulfones and polysulfones;
wherein all weight percentages are based on the weight of the entire composition.

2. The thermoplastic composition of claim 1, wherein the fiber is at least one of glass fiber and carbon fiber.

3. The thermoplastic composition of claim 1, wherein a molded test specimen made from the composition has a heat distortion temperature of at least about 250° C. under a 264 psi load as measured according to ASTM D648.

4. The thermoplastic composition of claim 1, wherein a ⅛-inch thick molded test specimen made from the composition has a tensile strength of greater than about 20,000 psi as measured according to ASTM D638.

5. The composition of claim 1, wherein an edge-gated injection molded test specimen made from the composition and having dimensions of about 4 inches wide by about 1/16 inch thick has a deviation from flatness of less than about 10 mm.

6, The composition of claim 1, wherein the crystalline polyamide is polyamide 4,6.

7. The composition of claim 1, wherein the polyetherimide is a reaction product of an aryl diamine with a dianhydride selected from the group consisting of: bisphenol-A dianhydride, pyromellitic dianhydride, benzophenone dianhydride, biphenylene dianhydride, and oxy-dianhydride.

8. The composition of claim 7, wherein the aryl diamine is selected from the group consisting of: meta phenylene diamine, para phenylene diamine, and oxy dianiline.

9. The composition of claim 1, wherein the amorphous thermoplastic resin has a glass transition temperature of greater than or equal to 200° C.

10. The composition of claim 1, wherein the fiber has a diameter between about 10-15 microns.

11. An article made of the composition of claim 1.

12. The article of claim 11, wherein the article has a least one snap fit connector integrally molded into the article.

13. The article of claim 11, wherein the article has at least one bonded metal outer layer.

14. The article of claim 13, wherein at least one bonded metal layer is deposited by metal sputtering or plating.

15. A thermoplastic resin composition consisting essentially of:
(a) about 80-10 wt. % of at least one crystalline polyamide having a melting point of greater than about 270° C.,
(b) about 10-50 wt. % fiber having a diameter between about 6-20 microns, and
(c) about 10-50 wt. % of at least one amorphous thermoplastic resin having a glass transition temperature above about 170° C. and selected from the group consisting of polyetherimides, polyimides, polyethersulfones and polysulfones;
wherein all weight percentages are based on the weight of the entire composition

16. A method for reducing the warp of molded fiber-reinforced compositions wherein said method comprises combining about 80-10 wt. % of at least one crystalline polyamide resin having a melting point of greater than about 270° C. and about 10-50 wt. % fiber having a diameter between about 6-20 microns with about 10-50-wt. % of at least one amorphous thermoplastic resin having a glass transition temperature above about 170° C. and selected from the group consisting of polyetherimides, polyimides, polyethersulfones and polysulfones; wherein all weight percentages are based on the weight of the entire composition.
